(19) United States
(12) Patent Application Publication
(10) Pub. No.: US 2002/0050982 A1
(43) Pub. Date: May 2, 2002

(54) Data form having a position-coding pattern detectable by an optical sensor

(76) Inventor: Petter Ericson, Malmo (SE)

Correspondence Address: BIRCH STEWART KOLASCH & BIRCH, PO BOX 747, FALLS CHURCH, VA, 22040-0747, US

(21) Appl. No.: 09/812,906

(22) Filed: Mar. 21, 2001

Related U.S. Application Data
(60) Provisional application No. 60/208,167, filed on May 31, 2000.

(30) Foreign Application Priority Data
Apr. 5, 2000 (SE) 0001236-9

(51) Int. Cl. G09G 5/00

(52) U.S. Cl. 345/173

(57) ABSTRACT

Disclosed is a form having a form layout with at least one entry field. It may be printed on a base in the form of a sheet (or any other surface). The surface of the base may have a position-coding pattern. The entry field can be completed using a user unit that has an optical sensor to detect positions on the sheet utilizing the position-coding pattern. The optical sensor can thereby enable digital recording of the information entered in the entry field. The surface may also have an identity pattern that can identify the form layout after recordation by the sensor of the locations defined by the identity pattern.

### CROSS-REFERENCE TO RELATED APPLICATIONS

This application claims priority benefits based on Swedish Patent Application No. 0001236-9, filed Apr. 5, 2000, and U.S. Provisional Application 60/208,167, filed May 31, 2000, the technical disclosures of both of which are hereby incorporated herein by reference.

### FIELD OF THE INVENTION

The invention relates generally to information processing and, more specifically, relates to data entry using optical sensor technology.

### BACKGROUND OF THE INVENTION

Forms and the like are used to a considerable extent in today's society. The aim of such forms is to ensure that a user fills in the correct information and that this is carried out in a structured way. Therefore, forms usually consist of a sheet of paper containing printed form layouts with instructions concerning what information is to be filled in and where.

With modern computer technology, it is possible to record automatically the information that is entered on a form. One way of doing this is with a flat-bed scanner connected to a computer system. This creates an information file in a graphical format (e.g., tiff format). Such simple recording makes it possible to create a copy of the form at a later stage. The copy can then be printed and interpreted manually.

It is also possible to process the created file by OCR technology that can recognize text both in the layout of the form and in the fields which have been filled in by a user. But doing so may require comprehensive and complicated image analysis software. Determining the identity and orientation of the form and identifying and deciphering the entries on the form may also be difficult.

Currently, if an individual does not have access to advanced flat-bed scanners and associated software that may be required for the subsequent image analysis of a scanned form, automatic form recordation may be difficult.

### SUMMARY OF A FEW ASPECTS OF THE INVENTION

Generally described, the invention includes a form. The form may have a surface. The surface may have a position-coding pattern detectable by an optical sensor. It may also have a form layout indicating at least one entry field for receipt of information. The surface may also have an identity pattern indicating positions on the surface that may be marked to identify the form layout.

Although it need not be, the identity pattern may be a bar code. The bar code may prevent the optical sensor from detecting the position-coding pattern on portions of the surface covered by bars of the bar code but allow the optical sensor to detect the position-coding pattern between the bars of the bar code.

The invention may also include a method for generating a form. A printer may print on a surface a position-coding pattern detectable by an optical sensor. The printer may also print on the surface a form layout indicating at least one entry field for receipt of information. Moreover, the printer may print on the surface an identity pattern indicating positions on the surface whose arrangement identifies the form layout. A computer program directing the printer to generate the form in this manner may be written in a computer-readable medium.

Additionally, a printer may generate a form by printing, on a surface having a position-coding pattern detectable by an optical sensor, a form layout indicating at least one entry field for receipt of information. On the surface, the printer may also print an identity pattern indicating positions on the surface whose arrangement identifies the form layout.

A computer program may process the form. To do so, it may receive from an optical sensor position data corresponding to movement of a device containing the optical sensor over a surface having a position-coding pattern detectable by the optical sensor. The program may then determine from the position data a form layout printed on the surface and determine from the position data an information entry in an entry field defined by the form layout.

The foregoing summarizes only a few aspects of the invention and is not intended to be reflective of the full scope of the invention as claimed. Additional features and advantages of the invention are set forth in the following description, apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

FIG. 1 shows an exemplary computer system in which the invention can operate, a base in the form of a sheet, and a user unit having an optical sensor.

FIG. 2 shows a form in accordance with an exemplary embodiment of the present invention.

FIG. 3 shows an identifying pattern in accordance with an exemplary embodiment of the present invention.

FIG. 4 shows the application of a number of rules with position information as input data in accordance with an exemplary embodiment of the present invention.

FIG. 5 shows a flow chart describing a method for generating forms in accordance with an exemplary embodiment of the present invention.

FIG. 6 shows a flow chart describing a method for recording form data for an information entry in accordance with an exemplary embodiment of the present invention.

### DETAILED DESCRIPTION OF THE PREFERRED EMBODIMENTS

Generally, the invention includes a form having a form layout with at least one entry field. It may be printed on a base in the form of a sheet (or any other surface). The surface of the base may have a position-coding pattern. The entry field can be completed using a user unit that has an optical sensor to detect positions on the sheet utilizing the position-coding pattern. The optical sensor can thereby enable digital recording of the information entered in the entry field. The surface may also have an identity pattern that can identify the form layout after detection by the sensor of the locations defined by the identity pattern.

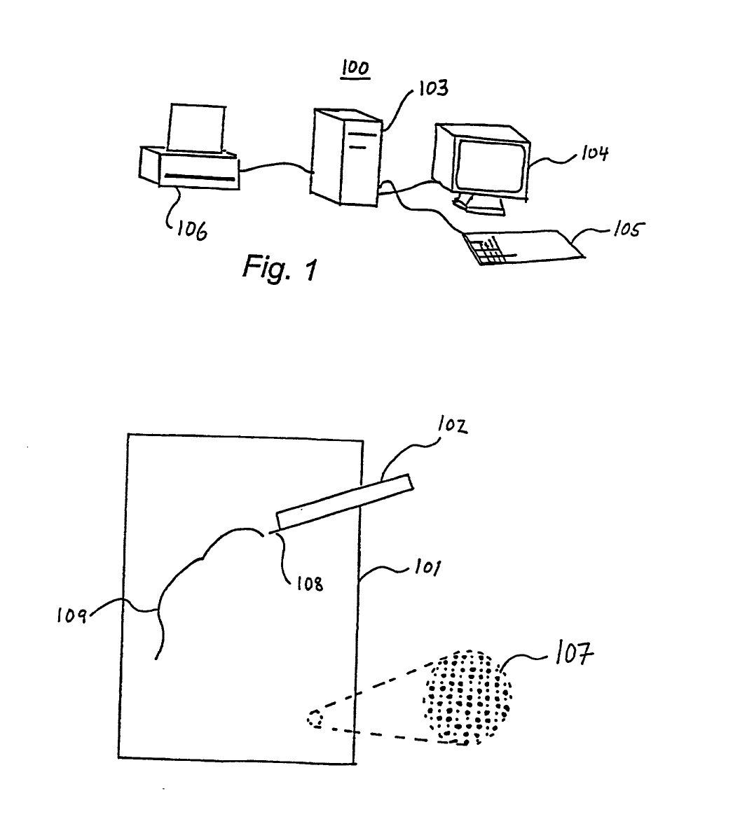

FIG. 1 shows a computer system 100 capable of generating and processing forms in accordance with typical embodiments of the present invention. FIG. 1 also depicts a base 101 in the form of a sheet and a user unit 102 having an optical sensor.

The computer system 100 may include personal computer 103 to which is connected a display 104 and a keyboard 105. But forms may be generated and processed by both larger and smaller computer systems than those shown in FIG. 1. The computer system 100 may include a printer 106, which may be a laser printer, an inkjet printer, or any other type of printer.

The base 101 can be a sheet of paper, but other materials such as a plastic, laminate, or other paper stock such as cardboard may provide a suitable surface on which to create a form. In such a form, the base 101 is provided with a position-coding pattern 107 (shown enlarged). The printer 106 may create the position-coding pattern 107, or the base 101 may be manufactured with the position-coding pattern.

The position-coding pattern 107 may be arranged so that if a part of the pattern of a certain minimum size is recorded optically, then this part of the pattern's position in the pattern and hence on the base can be determined unambiguously. The position-coding pattern can advantageously be of such a type as shown in Applicant's previous Applications WO 00/73983 and PCT/SE00/08195, the technical disclosures of both of which are hereby incorporated by reference.

In the position-coding patterns described in those applications, each position may be coded by a plurality of symbols or one symbol may be used to code a plurality of positions. The position-coding pattern 107 shown is constructed in accordance with WO 00/73983. A larger dot may represent a “one” and a smaller dot may represent a “zero.” The position coding pattern 107 may be of any other suitable design, such as the one described in SE00/01895, where different displacements of a dot in relation to a raster code different symbol values.

FIG. 1 also shows a user unit 102, which, by way of example only, is designed as a pen. The user unit 102 may have a pen point 108 that can be used to write text and numbers or draw figures on the base. The user unit 102 may also comprise an optical sensor that utilizes the position-coding pattern 107 on the base 101 to detect positions on the position-coding pattern. When a figure 109 is drawn on the base 101, the optical sensor may detect a sequence of positions on the base 101 that correspond to the movement of the user unit 102 over the base 101. This sequence of positions forms a digital record of the figure 109 drawn on the base 101. In the same way, hand-written numbers and letters can also be recorded digitally.

The information recorded by the user unit 102 can be transmitted to another unit, such as a personal computer or a cellular mobile telephone, for further processing, storage, or transmission. Transmission to such a peripheral device can be carried out by means of a cable, an infrared link, or a short-range radio link (such as one described by the BLUETOOTH standard). The position information that is transmitted can be the direct sequence of positions recorded by the optical sensor in the form of a set of pairs of coordinates or a polygon train. The position information may also be stored locally in the user unit and transmitted later, when a connection is established.

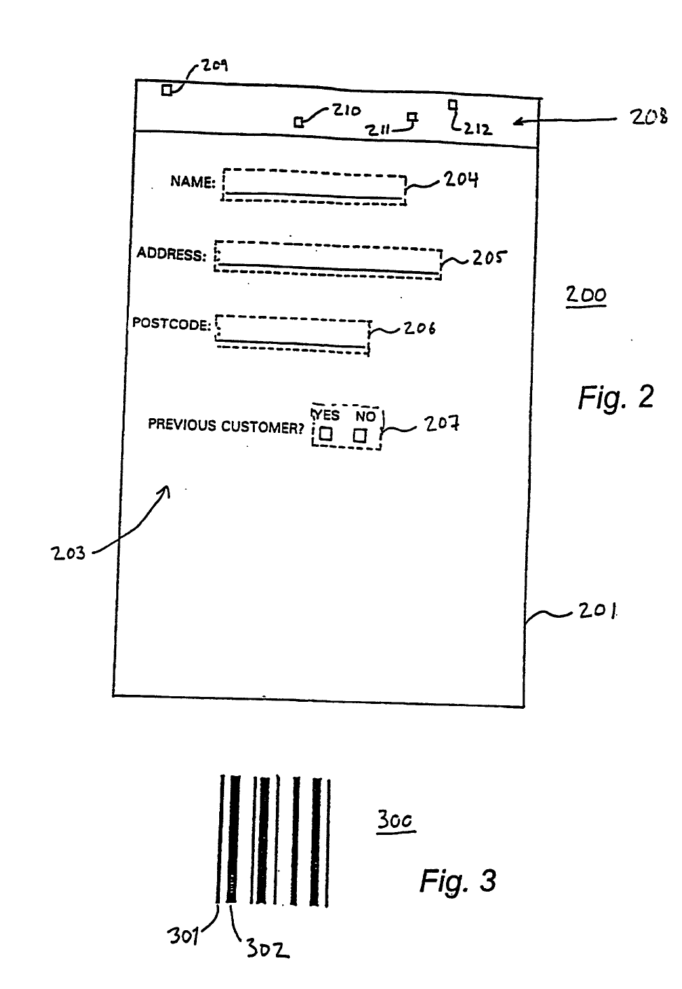

FIG. 2 shows a form 200 in accordance with an exemplary embodiment of the present invention. The form 200 consists of a base 201 (or any other surface) provided with a position-coding pattern (not shown in FIG. 2). A form layout 203 is also printed on the base 201. The form layout 203 comprises a plurality of entry fields 204-207. While the surface disclosed in the figures comprises a single discrete surface such as a sheet of paper, the term surface as used herein may refer to multiple surfaces or multiple pages of a multi-page form.

The form 200 may enable collection of information. For example, the user may write text or a number in any of the entry fields 204-207. Information provided by a user may be text (e.g., a name) or an address. It may also be a whole number, such as the age of a person in whole years, or a real number, such as a patient's body temperature in degrees Celsius to two decimal places. It can also be the reply to a multi-choice question. A form may enable the entry of other types of information, too.

The user may download the form layout from an Internet server. The form layout may also be stored in other computer systems, such as a user unit 102 with an optical sensor.

When an entry field 204-207 is completed by a user using a user unit 102, the user unit records a sequence of positions corresponding to a digital record of the entered information. The recorded information can then be processed or stored locally in the user unit. Alternatively, it can be transmitted to another computer system for processing or storage.

The form 200 may also comprise an identifying pattern or identity pattern 208, which may be marked when the entry fields 204-207 of the form layout 203 are completed. The identity pattern may be marked, for example, by drawing a cross through a box defined by the pattern or circling a location defined by the pattern. The user may instead be invited to fill in a missing feature in a figure.

In FIG. 2, the identifying pattern consists of four boxes 209-212. When these are marked with a cross using the user unit, a set of positions may be recorded by the optical sensor. By finding a matching set of positions in a database of position patterns representing possible form layouts, a computer processing the position data can determine the form layout 203 corresponding to the positions marked. The entry fields 204-207 and the four boxes 208 may be completed in any order.

The identifying pattern 208 may also be utilized to determine the scale in which the form layout has been printed in relation to the position-coding pattern. The boxes 209-212 may be placed near the different corners of the sheet in order to facilitate this and provide higher resolution. The information can then be used to normalize the position information which arises, so that the correct position information is associated with the correct information entry.

As an alternative to this method of normalizing, a printer creating the form can be provided with a position-coding pattern reading device. This allows the printer to print the form layout at a known location relative to the position-coding pattern. Also, a printer could print the form and, during the printing process, sense the position coordinates defining the form layout and feed the position coordinates back to the computer system.

A method of generating a form may generally involve printing a form layout, comprising at least one field entry, on a surface; detecting the positions in a position-coding pattern on which the form layout is superimposed; and transferring the positional relationship between the form layout and the position-coding pattern to the computer system that will process form input.

The identifying pattern may be over-specified by providing more position information than what is required to identify a form layout unambiguously. This may enable recording of scale information.

A user who wants to generate a number of forms may acquire a pack of sheets which are already provided with a position-coding pattern and load a number of such sheets into his/her printer. All the sheets in such a pack can be identical, but it is also possible for each sheet in a pack to be unique and code a separate coordinate area. The user can also in principle print the position-coding pattern himself using a printer having sufficiently high printing resolution.

The position-coding patterns described in Applicant's previous applications WO 00/73983 and PCT/SE00/01667 are able to define a very large total area (multiple A4-sized pages) with good resolution. The areas which are used in a pack of sheets that a user can acquire may be known to the system responsible for processing information entered on the form.

If the printer can print a form layout and identifying pattern accurately, the absolute positions in the position-coding pattern that are recorded when the boxes are marked can be utilized to identify the form layout. Alternatively, the relative positions of the different boxes in the position-coding pattern can be used to identify the form layout.

In FIG. 2, boxes 209-212 illustrate an exemplary identifying pattern 208. The boxes 209-212 may be marked with crosses. However, alternative identifying patterns may involve dots to be circled. An advantage of marking boxes 209-212 with a cross is that the width and intensity of the four lines which make up the box can be made such that the position recording temporarily ceases when the optical sensor crosses the lines of the box because the lines prevent the optical sensor from detecting the position-coding pattern (or the position-coding pattern does not exist there). This means that the system can determine more precisely where in the position-coding pattern the box is located.

This principle may also be used in the embodiment of the identifying pattern 300 shown in FIG. 3. Here the pattern 300 consists of a set of parallel lines 301, 302, etc., of different widths arranged beside each other (e.g., as a bar code). If the bar code is printed on a position-coding pattern and marked by having a line drawn through it essentially at right angles to the lines 301, 302, etc. using a user unit with an optical sensor, the position recording may be commenced and terminated several times as a result of interference of the bar-code lines with the detection of the position-coding pattern by the optical sensor. The positions which are recorded can be used to identify a form layout.

A form in accordance with the present invention may be put to numerous uses, including market surveys, tests, medical records, and income-tax returns. This list is not intended to be exhaustive, and the invention is contemplated for use in connection with any form in which information is to be recorded and/or conveyed.

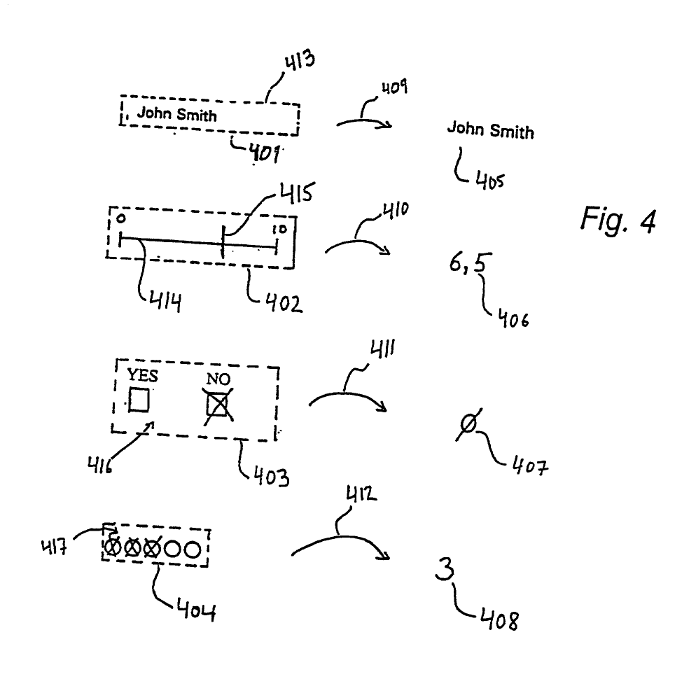

FIG. 4 shows the application of a number of rules or functions with position information as input data. On the left side of FIG. 4 is shown a number of entry fields 401-404, which may be completed by a user. On the right side of the figure is shown the information 405-408 which may be inserted in the corresponding information entries in a database when field-specific rules 409-412 of various kinds are applied to transform the items of position information (information entries) generated when the form is completed. Output data from such rules are generally obtained by processing the rule's input data.

In FIG. 4, a user has entered a name 413 in a first entry field 401. On the position information which then arose, a rule 409 is applied, which corresponds to OCR recognition of text on a sheet of paper. Output data 405 from this rule is thus a text string that can be stored or processed in the computer system. It is also possible to store the position information in an unprocessed state. One might want to do this to make a signature reproducible.

In a second entry field 402, the form layout consists of a scale 414 from 1 to 10 where a user may describe, for example, how satisfied he was with a particular product. The user has here put a line 415 slightly to the right of the center. When a rule 411 is applied to the position information which arose when the user marked the line 415, the output data 406 is a real number 6.5, which can be stored in an information entry in a database form.

In a third entry field 403, a user answers “yes” or “no” to a question. The form layout 416 consists of the words “yes” and “no” with associated boxes to be marked with crosses. The user has put a cross in the box signifying “no.” When a rule is applied to the position information which arose, the output data 407 may be a logical or Boolean zero.

In a fourth entry field 404, a user indicates how many items of a particular product he wants to order by marking a corresponding number of circles in box 417. The user has marked a cross in three circles. When a rule 412 is applied to the position information which arose, the output data 408 is the whole number 3.

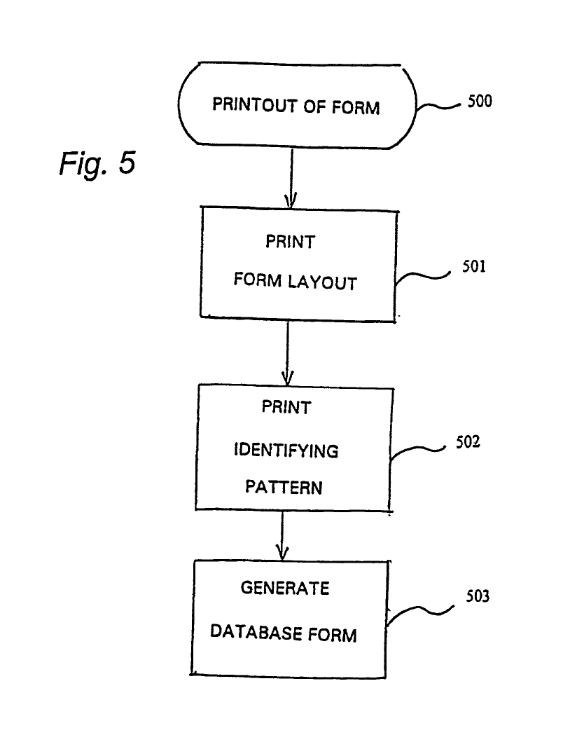

FIG. 5 shows a flow chart that describes a method 500 for generating forms in accordance with an exemplary embodiment of the present invention. A computer program may direct a printer to perform this method. In step 501, the form layout is printed. The actual form layout may include graphics and text that are not necessarily strictly related to the form functionality. In step 502, an identifying pattern (identity pattern) may be printed. This identity pattern may identify the form layout. In step 503, a database form is created in an associated computer system. The database form may be a virtual copy of the real form now created. Printing of the layout, printing of the identifying pattern, and printing of the position-coding pattern may all be printed simultaneously, but they could also be printed sequentially in any order.

The position-coding pattern may be arranged on the paper in advance, perhaps by an offset printer having a resolution above 1000 dpi. The form layout may then be printed on top of the position-coding pattern. Also, the printer may be provided with a position-coding pattern reader device in order to facilitate the printing of a form layout that is adapted to the position-coding pattern.

Alternatively, the position-coding pattern may be applied to the paper by a separate printer after printing the form layout, or with the same printer in a second run. It is also possible to use a copying machine for providing the paper with the form layout and/or the position-coding pattern.

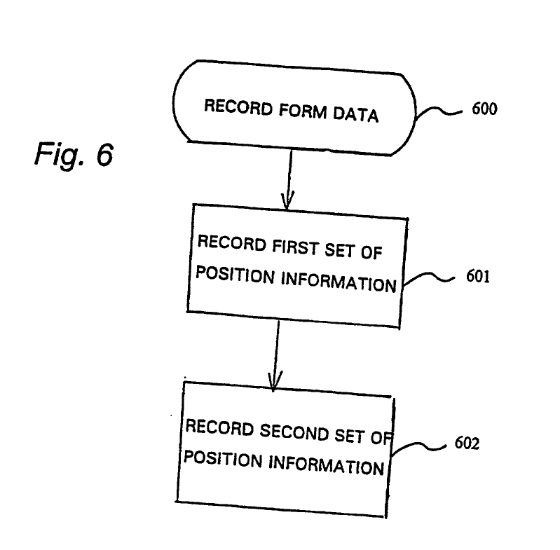

FIG. 6 shows a flow chart that describes a method 600 for recording and processing form data for an information entry in accordance with an exemplary embodiment of the present invention. A computer program may perform these steps. In step 601, a first set of position information, entered into an entry field, may be recorded. In step 602, a second set of position information, arising from marking of an identifying pattern with the user unit, may be recorded.

Generally, according to the invention, the positional relationship of a form layout and a position-coding pattern is established so that they may be coordinated.

While recording of a form created in accordance with the foregoing methods does not necessarily require a flat-bed scanner equipped with advanced software for image analysis, the invention in its broadest sense may be used in conjunction with many types of technology without departing from the scope or spirit of the invention. With the invention, forms may not need to be sent away, but can, for example, be retained as a copy of what was entered on it. Mobile recording can be carried out in the field. The computer system may be configured to process the entered information in a simple and structured way, reducing the danger of errors.

The scope of protection applied for is not restricted to the embodiments described above. The invention can be varied within the scope of the appended claims.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its pwn as a separate preferred embodiment of the invention.

What is claimed is:

1. A form, comprising:
a surface;
a position-coding pattern located on the surface and detectable by an optical sensor;
a form layout on the surface indicating at least one entry field for receipt of information; and
an identity pattern on the surface indicating positions on the surface that may be marked to identify the form layout.

2. The form of claim 1, wherein the identity pattern comprises a bar code.

3. The form of claim 1, wherein the identity pattern comprises a bar code that prevents the optical sensor from detecting the position-coding pattern on portions of the surface covered by bars of the bar code but allows the optical sensor to detect the position-coding pattern between the bars of the bar code.

4. The form of claim 1, wherein the identity pattern also indicates a scale of the form layout.

5. The form of claim 1, wherein the identity pattern comprises a box for receipt of a cross.

6. The form of claim 1, wherein the entry field comprises a shape to be marked.

7. The form of claim 1, wherein the entry field comprises a scale that can be marked at a location to indicate a numerical rating.

8. The form of claim 1, wherein the entry field comprises space for receiving handwritten information.

9. A method for generating a form, comprising:
printing on a surface a position-coding pattern detectable by an optical sensor;
printing on the surface a form layout indicating at least one entry field for receipt of information; and
printing on the surface an identity pattern indicating positions on the surface whose arrangement identifies the form layout.

10. The method of claim 9, wherein printing on the surface the form layout comprises printing the form layout at a known location relative to the position-coding pattern.

11. A printer adapted to perform the method of claim 9.

12. A computer-readable medium having computer-executable instructions for performing the method of claim 9.

13. A method for generating a form, comprising:
on a surface having a position-coding pattern detectable by an optical sensor, printing a form layout indicating at least one entry field for receipt of information; and
printing on the surface an identity pattern indicating positions on the surface whose arrangement identifies the form layout.

14. The method of claim 13, wherein printing on the surface the form layout comprises printing the form layout at a known location relative to the position-coding pattern.

15. A computer-readable medium having computer-executable instructions for performing the method of claim 13.

16. A method for processing a form, comprising:
receiving from an optical sensor position data corresponding to movement of a device containing the optical sensor over a surface having a position-coding pattern detectable by the optical sensor;
determining from the position data a form layout printed on the surface; and
determining from the position data an information entry in an entry field defined by the form layout.

17. The method of claim 16, further comprising storing the information entry in a database.

18. The method of claim 16, further comprising:
translating the information entry into a non-handwritten format based on a type of information expected to be received in the entry field; and
storing the translated information entry in a database.

19. The method of claim 16, further comprising:
translating the information entry into a result of a type chosen from the group consisting of Boolean variable, whole number, real number, and text string; and
storing the result in a database.

20. The method of claim 16, wherein determining from the position data the form layout printed on the surface comprises:
determining a sub-portion of the position data located in a predetermined area of the position-coding pattern;
finding a match to the sub-portion in a plurality of known identity patterns representing possible form layouts; and
determining the form layout corresponding to the match.

21. The method of claim 16, wherein determining from the position data the information entry in the entry field defined by the form layout comprises determining a sub-portion of the position data whose location falls in an area of the position-coding pattern known to be encompassed by the entry field.

22. A computer-readable medium having computer-executable instructions for performing the method of 16.

23. A method for electronically collecting information from forms, the method comprising:
providing a user with a form, the form containing printed indicia on a foreground thereof prompting the user to associate written information with the printed indicia, wherein the form further includes preprinted coded information in the background thereof;
encouraging the user to fill in portions of the form using an implement capable of marking the form, the implement being further capable of detecting the preprinted coded information over which the implement passes and generating a signal in response thereto; and
electronically receiving the signal and translating the signal into information reflecting an intention of the user.

24. The method of claim 23, further including storing in a database the information reflective of the user's intention.

25. The method of claim 23, wherein the form is printed on a material chosen from the group consisting of paper stock, plastic, and laminate.

26. The method of claim 23, wherein the written information is hand-written.

27. The method of claim 23, wherein the implement is in the form of a pen having an optical code reader therein.
